(19) United States
(12) Patent Application Publication
(10) Pub. No.: US 2006/0091277 A1
(43) Pub. Date: May 4, 2006

(54) Telescopic stand of a decorative tree

(76) Inventor: Sheng-Chien Wang, Taichung Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/978,594

(22) Filed: Nov. 1, 2004

(51) Int. Cl. F16B 7/10

(52) U.S. Cl. 248/405

(57) ABSTRACT

A telescopic stand for a decorative tree has a base, a telescopic tube assembly and a telescopic actuated assembly. The base is hollow and has an outer tube mounted thereon. The telescopic tube assembly has multiple tubes. The tubes are telescopic and are mounted slidably in the outer tube on the base. The telescopic actuated assembly is mounted in the base and the telescopic tube assembly, and expands and retracts the telescopic tube assembly. Therefore a decorative tree with the telescopic stand can be expanded when used and retracted when stowed.

### BACKGROUND OF THE INVENTION

1. Field of the Invention

The present invention relates to a stand, especially to a telescopic stand for a decorative tree.

2. Description of the Prior Arts

Decorative trees are usually displayed in shopping malls or department stores to celebrate festivals and so on. A conventional decorative tree comprises a base and a central pole. The central pole is mounted on the base and has multiple branches and ornaments displayed on the branches. However, the central pole of the conventional decorative tree has a fixed height and cannot be retracted. When the conventional decorative tree has to be moved or to be stowed, the central pole will occupy a huge part of the space, which is particularly troublesome as the tree may be used for only a few days each year. To overcome the shortcomings, the present invention provides a telescopic stand for a decorative tree to mitigate or obviate the aforementioned problems.

### SUMMARY OF THE INVENTION

The main objective of the present invention is to provide a telescopic stand for a decorative tree. The stand has a base, a telescopic tube assembly and a telescopic actuated assembly. The base is hollow and has an outer tube mounted on a top face of the base. The telescopic tube assembly has multiple tubes that are telescopic and mounted slidably in the outer tube on the base. The telescopic actuated assembly is mounted in the base and the telescopic tube assembly and expands and retracts the telescopic tube assembly. Therefore the stand can be extended when required and retracted when to be stowed.

Other objectives, advantages and novel features of the invention will become more apparent from the following detailed description when taken in conjunction with the accompanying drawings.

### BRIEF DESCRIPTION OF THE DRAWINGS

FIG. 1 is a front view in partial section of a telescopic stand for a decorative tree in accordance with the present invention;

FIG. 2 is a partial front view in partial section of the stand in FIG. 1; and

FIG. 3 is a front view in partial section of the stand in FIG. 1 when the stand is erected.

### DETAILED DESCRIPTION OF THE PREFERRED EMBODIMENTS

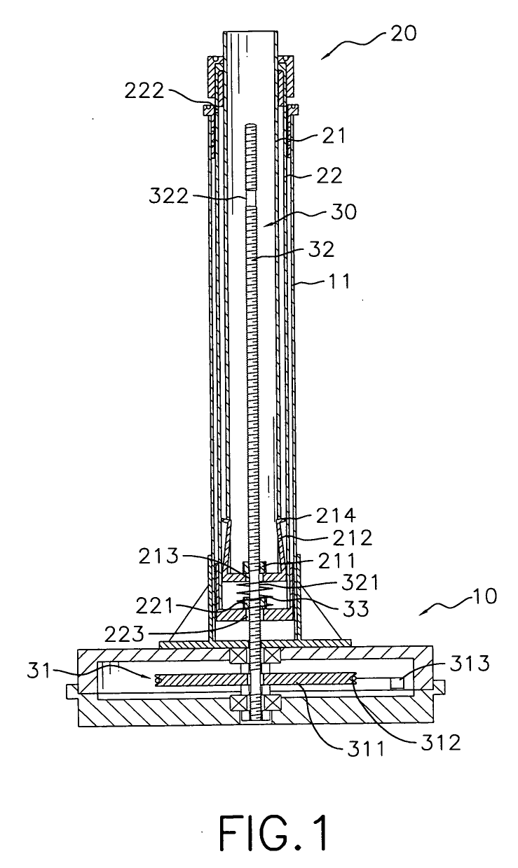

With reference to FIG. 1, a telescopic stand for a decorative tree in accordance with the present invention comprises a base (10), a telescopic tube assembly (20) and an actuating assembly (30).

The base (10) is hollow and has an inner surface, an upper surface, a central hole and an outer tube (11). The central hole is formed in the upper surface. The outer tube (11) is mounted securely on the upper surface and has an axial hole. The axial hole in the outer tube communicates with the central hole.

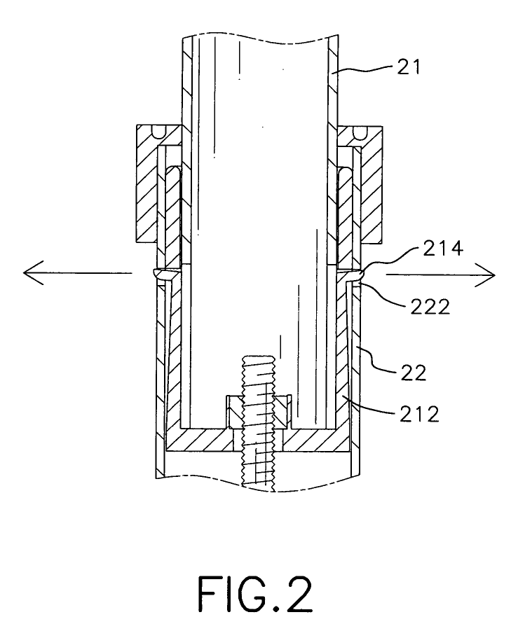

With further reference to FIG. 2, the telescopic tube assembly (20) is mounted slidably mounted in the outer tube (11) on the base (10) and has multiple tubes (21,22). The tubes are telescopic and may comprise a primary tube (22) and a secondary tube (21). The primary tube (22) is mounted slidably in the outer tube (11) and has a top end, a bottom end, an outer surface, a through hole (223), a telescopic activator (221) and a positioning hole (222). The through hole (223) is formed in the bottom end of the primary tube (22) and corresponds to the central hole in the base (10). The telescopic activator (221) is mounted securely on the bottom end of the primary tube (22) and has an axial hole and an inner thread. The axial hole in the telescopic activator (221) communicates with the through hole (223) in the primary tube (22). The inner thread is formed in the axial hole in the telescopic activator (221). The positioning hole (222) is transversely defined through a side wall of the primary tube (22), and near a top end of thereof. The secondary tube (21) is mounted slidably in the primary tube (22) and has a top end, a bottom end, an outer surface, a through hole (213), a telescopic activator (211) and a resilient element (212). The through hole (213) is formed in the bottom end of the secondary tube (21) and corresponds to the through hole (223) in the primary tube (22). The telescopic activator (211) is mounted securely on the bottom end of the secondary tube (21) and has an axial hole and an inner thread. The axial hole in the telescopic activator (211) communicates with the through hole (213) in the primary tube (21). The inner thread is formed in the axial hole. The resilient element (212) is formed in the outer surface and the bottom end of the secondary tube (21) and has a proximal end, a distal end and a head (214). The head (214) is formed on the distal end of the resilient element (212) and selectively engages the positioning hole (222) in the primary tube (22). It is to be understood that each the head (214) and positioning hole (222) may be singular or multiple.

The telescopic actuating assembly (30) is mounted in the base (10) and the telescopic tube assembly (20), and expands and retracts the tubes (21,22) of the telescopic tube assembly (20). The telescopic actuating assembly (30) may comprise a transmission (31), a screw shaft (32) and a biasing member. The transmission (31) is mounted in the base (10) and may have a pulley (311), a belt (312) and a motor assembly (313). The belt (312) is reeved around the pulley (311). The motor assembly (313) drives the belt (312) to rotate the pulley (311). The screw shaft (32) connects to and is driven by pulley (311) of the transmission (31), passes through the central hole in the base (10) and the through holes (213, 223) and the telescopic activator (211, 221) of the secondary and primary tubes (21, 22) and has a top end, a bottom end, an outer thread, a top stop section (322) and a bottom stop section (321). The outer thread selectively engages the inner thread in the telescopic activators (211, 221) of the secondary and primary tubes (21, 22). The top stop section (322) is formed on the screw shaft (32) near the top end of the screw shaft (32). The bottom stop section (321) is formed on the screw shaft (32) near the bottom end of the screw shaft (32). The biasing member is mounted securely on the bottom end of the primary tube (22) around the screw shaft (32), selectively presses against the bottom end of the secondary tube (21) and may be a spring (33).

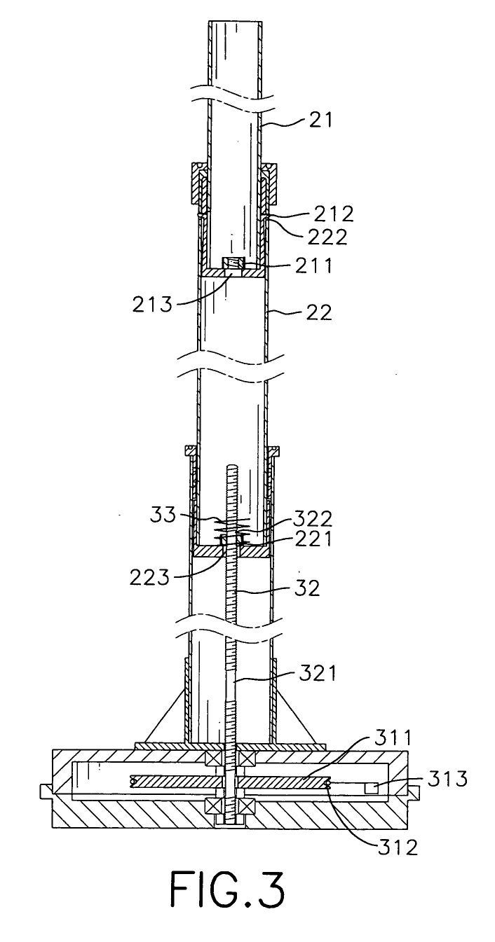

With further reference to FIG. 3, the telescopic activators (211, 221) correspond to the bottom stop section (321) on the screw shaft (32) when the stand is in a retracted position. When the stand of the telescopic decorative tree is expanded, the transmission (31) drives the screw shaft (32) to rotate. The spring (33) pushes the secondary tube (21) to let the telescopic activator (211) of the secondary tube (21) engage the outer thread on the screw shaft (32). When the screw shaft (32) is rotated, the telescopic activator (211) of the secondary tube (21) moves along the screw shaft (32) to drive the secondary tube (21) to move upward. When the secondary tube (21) keeps moving upward, the head (214) of the resilient element (212) in the bottom end of the secondary tube (21) will engage the positioning hole (222) near the top end of the primary tube (22). Then the primary tube (22) will be moved upward to leave the bottom stop section (321) on the screw shaft (32) by the engagement between the head (214) and the positioning hole (222) and the telescopic activator (221) of the primary tube (22) will engage the outer thread on the screw shaft (32). The telescopic activator (221) of the primary tube (22) moves along the screw shaft (32) to drive the primary tube (22) to move upward. When the telescopic activator (221) of the primary tube (22) moves onto the top stop section (322) on the screw shaft (32), the telescopic activator (221) of the primary tube (22) cannot move along the outer thread on the screw shaft (32) anymore so the tubes (21, 22) will stop moving upward. Therefore the telescopic tube assembly (20) can be expanded.

When the telescopic tube assembly (20) is to be retracted, the transmission (31) drives the screw shaft (32) to rotate in reverse. Because of the weight of the above-mentioned components of the tree, the telescopic activator (221) of the primary tube (22) will engage the outer thread on the screw shaft (32). The telescopic activator (221) of the primary tube (22) moves along the outer thread on the screw shaft (32) to drive the primary tube (22) to move downward. Because of the engagement between the head (214) and the positioning hole (222), the secondary tube (21) will move downward with the primary tube (22) until the telescopic activator (211) of the secondary tube (21) engages the outer thread on the screw shaft (32). When the telescopic activator (221) of the primary tube (22) moves onto the bottom stop section (321) and disengages from the outer thread, the primary tube (22) stops moving downward. Because the telescopic activator (211) of the secondary tube (21) still engages the outer thread, the head (214) on the resilient element (212) is forced to disengage from the positioning hole (222). Then the secondary tube (21) will keep moving downward until the telescopic activator (211) of the secondary tube (21) moves onto the bottom stop section (321) and disengages from the outer thread. Therefore the telescopic tube assembly (20) can be retracted.

The telescopic stand for a decorative tree as described can be expanded and retracted. When the decorative tree with the telescopic stand has to be used, it can be expanded, decorated and placed as desired. When the decorative tree is not required, it can be retracted and be stowed.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A telescopic stand for a decorative tree comprising
a base being hollow and having
an inner surface;
an upper surface;
a central hole formed in the upper surface; and
an outer tube mounted securely on the upper surface and having an axial hole communicating with the central hole;
a telescopic tube assembly mounted slidably mounted in the outer tube on the base and having multiple tubes that are telescopically arranged; and
a telescopic actuating assembly mounted in the base and the telescopic tube assembly to expand and retract the tubes of the telescopic tube assembly.

2. The stand as claimed in claim 1, wherein
the tubes of the telescopic tube assembly comprise
a primary tube mounted slidably in the outer tube and having
a top end;
a bottom end;
an outer surface;
a through hole formed in the bottom end of the primary tube and corresponding to the central hole in the base;
a telescopic activator mounted securely on the bottom end of the primary tube and having
an axial hole communicating with the through hole in the primary tube; and
an inner thread formed in the axial hole; and
a positioning hole formed in the outer surface near the top end of the primary tube;
a secondary tube mounted slidably in the primary tube and having
a top end;
a bottom end;
an outer surface;
a through hole formed in the bottom end of the secondary tube and corresponding to the through hole in the primary tube;
a telescopic activator mounted securely on the bottom end of the secondary tube and having
an axial hole communicating with the through hole in the secondary tube; and
an inner thread formed in the axial hole; and
a resilient element formed in the outer surface and the bottom end of the secondary tube and having
a proximal end;
a distal end; and
a head formed on the distal end of the resilient element and selectively engaging the positioning hole in the primary tube; and
the telescopic actuating assembly comprises
a transmission mounted in the base;
a screw shaft connecting to and driven by the transmission, extending through the central hole in the base and the through holes and the telescopic activator of the secondary and primary tubes and having
a top end;
a bottom end;
an outer thread selectively engaging the inner thread in the telescopic activators of the secondary and primary tubes;
a top stop section formed on the screw shaft near the top end of the screw shaft; and
a bottom stop section formed on the screw shaft near the bottom end of the screw shaft; and
a biasing member mounted securely on the bottom end of the primary tube around the screw shaft and selectively pressing against the bottom end of the secondary tube.

3. The stand as claimed in claim 2, wherein the transmission comprises
a pulley driving the screw shaft;
a belt mounted around the pulley; and
a motor assembly connected to the belt to drive the belt to rotate the pulley.

4. The stand as claimed in claim 1, wherein the biasing member of the telescopic actuated assembly is a spring.
